(19) United States
(12) Patent Application Publication
(10) Pub. No.: US 2004/0010801 A1
(43) Pub. Date: Jan. 15, 2004

(54) Video geographic information system

(76) Inventors: Kyong Ho Kim, Taejon (KR); Jong Hun Lee, Seoul (KR)

Correspondence Address: JACOBSON, PRICE, HOLMAN & STERN, PROFESSIONAL LIMITED LIABILITY COMPANY, 400 Seventh Street, N.W., Washington, DC, 20004, US

(21) Appl. No.: 10/300,809

(22) Filed: Nov. 21, 2002

(30) Foreign Application Priority Data
Jul. 13, 2002 (KR) 2002 - 40933

(51) Int. Cl. H04N 7/173; H04N 7/18; H04N 9/47; H04N 7/16

(52) U.S. Cl. 725/86; 725/87; 725/117; 725/147; 348/94

(57) ABSTRACT

There is provided a video geographic information system for supplying the geographic information, which is maximized in a sense of reality, in a dynamic environment without a pre-processing for camera information and video stream, the system comprising a video server to load a video stream stored in a database and to transmit out of the video server through a network; a Geo server to load camera information stored in the database if image information and video frame information are input from the outside through a network, to retrieve geographic information stored in the database, to process the retrieved geographic information corresponding to a user request of queries and analysis, and to transmit the processed geographic information out of the Geo server through a network; a video player to receive a video stream from the video server through a network, to output the video stream, and to output image information and video frame information corresponding to a user request of selection, queries, analysis for an output video image of the video stream out of the video player; and a Geo player to receive the image information and the video frame information from the video player, to transmit to the Geo server, to receive processed geographic information from the Geo server, and to send to the video player so that the processed geographic information corresponding to the user request is output together with the video image which the video player outputs.

### BACKGROUND OF THE INVENTION

1. Field of the Invention

The present invention relates to a geographic information system (GIS), and more particularly, to a video geographic information system for supplying geographic information based on a video stream.

2. Discussion of the Related Art

Generally, a conventional technology to supply geographic information is operated in such a manner of first supplying graphic information to a user by using two or three dimensional coordinates, and then, outputting information or spatial analysis results for the geographic object selected by a user as a form of graphic, text, image, sound or moving images, etc.

However, since the conventional technology is originally just based on two or three dimensional graphic images, the displayed graphic images are far away from the shape of a real object, and hardly look realistic enough for a user, which is a serious disadvantage.

### SUMMARY OF THE INVENTION

Accordingly, the present invention is directed to a video geographic information system that substantially obviates one or more problems due to limitations and disadvantages of the related art.

An object of the present invention is to provide a video geographic information system for outputting processed results corresponding to a user request of selection, queries, or analysis as various forms of, for example, graphic, text, image, etc. together with a video image while enabling a user to play a video stream and see the video image thereof

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a video geographic information system comprises a video server configured to load a video stream stored in a database and to transmit out of the video server through a network; a Geo server configured to load camera information stored in the database if image information and video frame information are input from the outside through a network, to retrieve geographic information stored in the database, to process the retrieved geographic information corresponding to a user request of queries and analysis, and to transmit the processed geographic information out of the Geo server through a network; a video player configured to receive a video stream from the video server through a network, to output the video stream, and to output image information and video frame information corresponding to a user request of selection, queries, analysis for an output video image of the video stream out of the video player, and a Geo player configured to receive the image information and the video frame information from the video player, to transmit to the Geo server, to receive processed geographic information from the Geo server, and to send to the video player so that the processed geographic information corresponding to the user request is output together with the video image which the video player outputs.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a diagram of a video geographic information system according to the present invention;

FIG. 2 is a view of the video stream, the camera information, and the geographic information stored in the database of FIG. 1;

FIG. 3 is a view of the operational state of the video server and the video player of FIG. 1; and

FIG. 4 is a view of the operational state of the video player, the Geo player, and the Geo server of FIG. 1.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

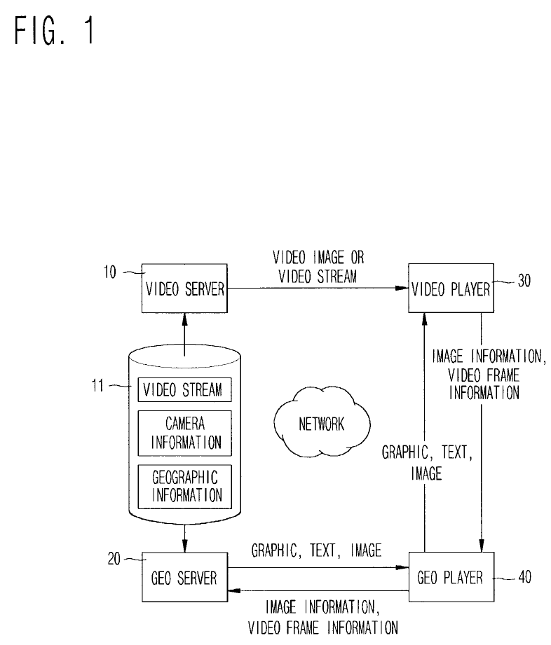

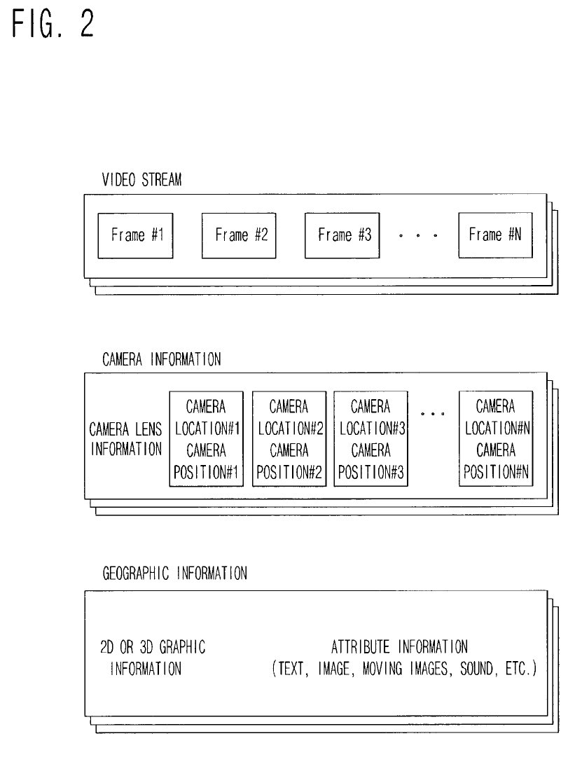

Referring to FIGS. 1 and 2, a video server 10 loads a video stream stored in a database 1l, and transmits out of the video server 10 through a network.

If image information and video frame information are input from the outside through a network, a Geo server 20 loads camera information stored in the database 11 and retrieves geographic information stored in the database 11, and then, processes the retrieved geographic information corresponding to a user request of queries and analysis, and transmits the processed geographic information out of the Geo server 20 through a network.

One of the video streams stored in the database 11 includes video images including a number of N frames.

One camera information corresponds to one of the video streams stored in the database 11, and the camera information includes the lens information of the video camera which is used at the time of acquisition of the video stream, and the location and position information of the camera at the time of acquiring the image of each frame in the video stream. The location information of the camera can be illustrated as information of xyz coordinates, and the position information of the camera can be illustrated as information of rolling, pitching, and yawing.

The geographic information stored in the database 11 is information for a geographic object, and includes graphic information of two or three dimensional coordinates, and attribute information including text, image, moving images, and sound, etc.

A video player 30 receives a video stream from the video server 10 through a network, and outputs. Also, if there is a user request of selection, queries, and analysis for the displayed video image, the video player 30 outputs image information and video frame information corresponding to the user request out of the video player 30.

A Geo player 40 receives image information and video frame information from the video player 30, and transmits them to the Geo server 20. The Geo player 40 also receives processed geographic information from the Geo server 20, and transmits to the video player 30 so that the processed geographic information corresponding to the user request is output together with a video image which the video player 30 outputs.

The video geographic information system structured as above according to the present invention operates as follows.

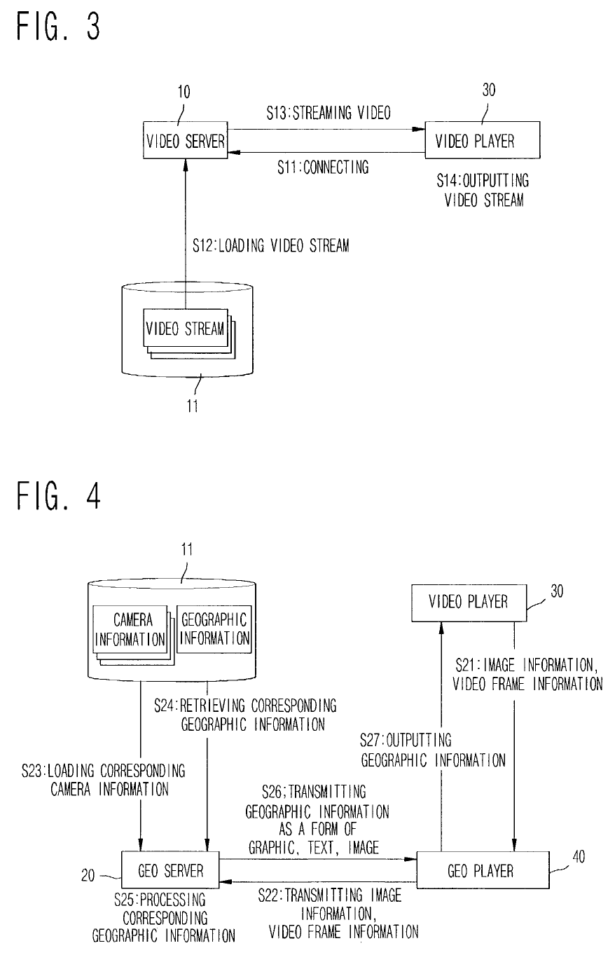

Referring to FIG. 3, if the video player 30 connects to the video server 10 and requests a transmission of a video stream including video images (S11), the video server 10 first loads the video stream, which is requested by the video player 30, from the database 11 (S12).

Then, the video server 10 transmits or streams the loaded video stream to the video player 30 through a network (S13), and accordingly, the video player 30 outputs the transmitted video stream including video images (S14).

Referring to FIG. 4, if there is a user request of selection, queries or analysis for the video image which the video player 30 outputs, the video player 30 transmits image information and video frame information corresponding to the user request to the Geo player 40 (S21).

The image information includes the size of the video image which the video player 30 outputs and image coordinates, and the video frame information includes the number of a corresponding video frame, etc.

Then, the Geo player 40 transmits the image information and the video frame information, which are transmitted from the video player 30 corresponding to a user request, to the Geo server 20 through a network (S22).

Accordingly, the Geo server 20 first loads corresponding camera information from the database 11 by using the received video frame information from the Geo player 40 (S23), and then, retrieves corresponding geographic information from the database 11 by using the camera information loaded from the database 11 and the image information transmitted from the Geo player 40 (S24).

In addition, the Geo server 20 performs querying and analyzing, etc. for the retrieved geographic information corresponding to a user request, and processes the results as a specific form of, for example, graphic, text, and image, etc. which is suitable for being output by the video player 30 (S25).

The geographic information processed by the Geo server 20 is transmitted to the Geo player 40 through a network, and the Geo player 40 transmits the processed geographic information received from the Geo server 20 to the video player 30 so that the geographic information processed corresponding to the user request is illustrated as a form of graphic, text, and image, etc. together with the video image which the video player 30 outputs (S27).

Described as above, the video geographic information system according to the present invention has an advantage of supplying geographic information as a form of graphic, text, and image, etc. based on a video stream including video images in a dynamic environment to maximize the reality of a geographic object and the usability of the output geographic information unlike the conventional technology which is based just on two or three dimensional graphic. In addition, a specific pre-processing for camera information and video stream is not necessary.

The above embodiment is just one example of a video graphic information system according to the present invention, and it will be apparent to those skilled in the art that various modifications and variations can be made in the present invention. Thus, it is intended that the present invention covers the modifications and variations of this invention provided they come within the scope of the appended claims and their equivalents.

What is claimed is:

1. A video geographic information system comprising:
a video server configured to load a video stream stored in a database and to transmit out of the video server through a network;
a Geo server configured to load camera information stored in the database if image information and video frame information are input from the outside through a network, to retrieve geographic information stored in the database, to process the retrieved geographic information corresponding to a user request of queries and analysis, and to transmit the processed geographic information out of the Geo server through a network;
a video player configured to receive a video stream from the video server through a network, to output the video stream, and to output image information and video frame information corresponding to a user request of selection, queries, analysis for an output video image of the video stream out of the video player; and
a Geo player configured to receive the image information and the video frame information from the video player, to transmit to the Geo server, to receive processed geographic information from the Geo server, and to send to the video player so that the processed geographic information corresponding to the user request is output together with the video image which the video player outputs.

2. The video geographic information system of claim 1, wherein one of the video streams stored in the database includes video images including a number of N frames, and corresponds to one camera information.

3. The video geographic information system of claim 2, wherein one camera information corresponding to one of the video streams stored in the database includes lens information of a video camera which is used at the time of acquisition of the video stream, and location information and position information of the camera at the time of acquiring image of each frame in the video stream.

4. The video geographic information system of claim 1, wherein the geographic information stored in the database is information for a geographic object, and comprises graphic information of two or three dimensional coordinates, and attribute information including text, image, moving images, and sound.

5. The video geographic information system of claim 1, wherein the Geo server processes the geographic information retrieved from the database as a form of graphic, text, image, and transmits to the Geo player through a network.
